(19) United States
(12) Patent Application Publication
(10) Pub. No.: US 2006/0245651 A1
(43) Pub. Date: Nov. 2, 2006

(54) Symptom based custom protocols

(75) Inventor: Susan M. Quinion, Oconomowoc, WI (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/115,469

(22) Filed: Apr. 27, 2005

(51) Int. Cl. G06K 9/00

(52) U.S. Cl. 382/181

(57) ABSTRACT

Certain embodiments of the present invention provide a system, method and computer instructions for protocol selection. In an embodiment, a protocol selection system includes: an input module for inputting procedure data; a protocol selection module for selecting a protocol based on the procedure data; and an output module for outputting a selected protocol. The protocol selection system may also include: a protocol editing module for editing a protocol; an exam package module for outputting exam package information based on a selected protocol; and a billing module for outputting billing information based on a selected protocol, for example.

### BACKGROUND OF THE INVENTION

The present invention generally relates to a system, method and computer instructions for protocol selection. More particularly, the present invention relates to a system, method and computer instructions for inputting procedure data, selecting a protocol, and outputting a selected protocol. The present invention also relates to a system, method and computer instructions for editing a selected protocol, outputting exam information based on a selected protocol and/or outputting billing information based on a selected protocol.

Imaging systems are used to aid in the monitoring and/or diagnosis of ailments. Two types of imaging techniques utilized by imaging systems are Computed Tomography (CT) imaging and Magnetic Resonance (MR) imaging. The images collected using an imaging system are referred to collectively as an imaging study. In order to learn as much as possible from an imaging study, certain procedures are employed that define what images will be acquired, how such images will be acquired and processed, how images will be displayed, and where images will be sent. Such procedures are known as protocols.

Currently, technologists select protocols manually. The process starts when an exam requiring imaging is entered into a Hospital Information System (HIS) or a Radiology Information System (RIS). A radiologist then receives a print-out containing information regarding the imaging order. The radiologist then provides instructions to the technologist about an appropriate protocol(s). Radiologists may base their selection of a protocol(s) on such factors as: what procedure was requested (for example, CT head); current symptoms (for example, dizziness, confusion, stroke, etc.); and/or patient history (for example, acute episode, trauma, chronic condition, previous studies, etc.). Once a radiologist selects a protocol(s), the radiologist may communicate that selection to a technologist verbally or in writing (often via a sticky note attached to a requisition).

Once the technologist is informed of the protocol(s) defined by the radiologist, the technologist manually selects the protocol(s) from a graphical user interface of a workstation. The graphical user interface of the workstation first displays regions of the body so that the region of interest may be selected. Then, after a region of the body is selected, a list of protocols is displayed. The list of protocols may include hundreds of protocols. Once the desired protocol is selected, the technologist may manually edit the protocol(s) to customize the protocol for the patient.

Once a protocol(s) for a procedure is selected and customized, the procedure is performed. After the procedure is performed, the procedure must be billed. Currently, to bill a procedure, a billing specialist manually reconciles International Classification of Diseases (ICD-9) codes with Current Procedural Terminology (CPT) codes.

The current process for protocol selection and billing is a burden on healthcare professionals and healthcare systems and leaves room for mistakes. First, information contained on an HIS/RIS is printed, using healthcare facility resources. Second, a radiologist reviews the materials and decides which protocol should be used, using the radiologist's time. Third, a technologist manually selects the protocol from a possibly large list of protocols, using the technologist's time. Fourth, the number of customized protocols stored on a healthcare system may continue to grow, consuming more system resources and possibly creating redundant entries in the system. Fifth, a billing specialist manually processes billing, using the billing specialist's time. Finally, the current process for protocol selection and billing leaves room for mistakes resulting from miscommunications and/or human error.

Thus, there is a need for an improved system, method and computer instructions for protocol selection and billing, which reduces the burden on healthcare professionals and healthcare systems and lowers the risk of mistakes creeping into the protocol selection process.

### BRIEF SUMMARY OF THE INVENTION

Certain embodiments of the present invention provide a system, method and computer instructions for protocol selection. In an embodiment, a protocol selection system includes: an input module for inputting procedure data; a protocol selection module for selecting a protocol based on the procedure data; and an output module for outputting a selected protocol. The protocol selection system may also include: a protocol editing module for editing a protocol; an exam package module for outputting exam package information based on a selected protocol; and a billing module for outputting billing information based on a selected protocol, for example.

In an embodiment, a method for protocol selection includes: inputting procedure data; selecting a protocol based on the procedure data; and outputting a selected protocol. The method for protocol selection may also include: editing a protocol; outputting exam package information based on a selected protocol; and outputting billing information based on a selected protocol, for example.

In an embodiment, a computer-readable storage medium includes a set of instructions for a computer directed to protocol selection. The set of instructions includes: an input routine for inputting procedure data; a protocol selection routine for selecting a protocol based on the procedure data; and an output routine for outputting a selected protocol. The set of instructions may also include: a protocol editing routine for editing a protocol; an exam package routine for outputting exam package information based on a selected protocol; and a billing routine for outputting billing information based on a selected protocol, for example.

These and other features of the present invention are discussed or apparent in the following detailed description of certain embodiments of the invention.

### BRIEF DESCRIPTION OF THE DRAWINGS

FIG. 1 illustrates a protocol selection system used in accordance with an embodiment of the present invention.

FIG. 2 illustrates a method for protocol selection used in accordance with an embodiment of the present invention.

FIG. 3 illustrates a set of computer instructions for protocol selection used in accordance with an embodiment of the present invention.

FIG. 4 illustrates a protocol selection system used in accordance with an embodiment of the present invention.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

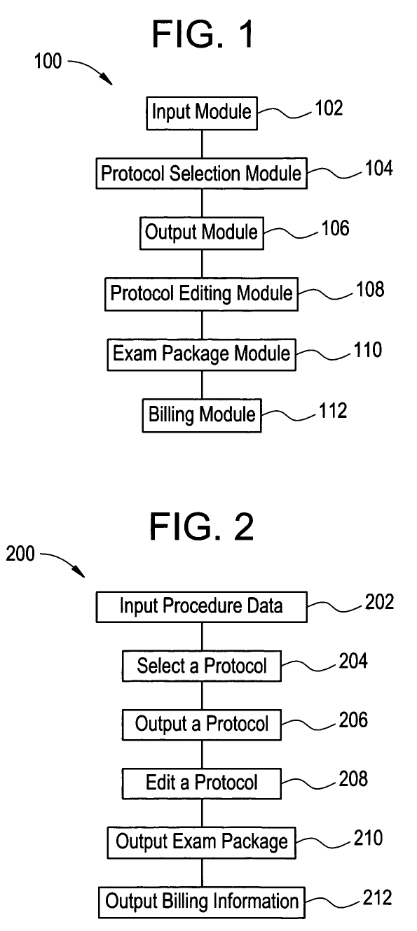

FIG. 1 illustrates a protocol selection system 100 for selecting a protocol(s) used in accordance with an embodiment of the present invention. The protocol selection system 100 includes an input module 102, a protocol selection module 104, an output module 106, a protocol editing module 108, an exam package module 1 10, and a billing module 112. The modules of the system 100 may be implemented in many ways. For example, the modules may be implemented in hardware and/or software. The modules may be implemented separately and/or integrated in various combinations. Other desirable ways to implement the modules of the system 100 may exist, as known to those skilled in the art.

The system 100 may also be implemented in many ways. For example, the system 100 may be integrated with existing applications that run on a Microsoft® platform and/or other platforms as an add-on product. In one implementation, the system 100 may be integrated with a workstation(s) that is connected to a Hospital Information System (HIS) and/or a Radiology Information System (RIS), such as a Modality Worklist workstation and/or a Picture Arching and Communicating System (PACS) workstation, for example. Other desirable ways to implement the system 100 may exist, as known to those skilled in the art.

In the protocol selection system 100, the input module 102 allows procedure data to be input. As described below, the input module 102 may be configured to allow various types of procedure data to be input from various sources. The procedure data is then used by the protocol selection module 104 to select a protocol(s). As described below, the protocol selection module 104 may be configured to select a protocol(s) based on various types of procedure data. Once a protocol(s) is selected, the selected protocol(s) may be output using the output module 106. As described below, the output module 106 may be configured to output a selected protocol(s) in various ways. After a protocol(s) is output, the protocol may be edited using the protocol editing module 108. As described below, the protocol editing module may be configured to allow modification of a selected protocol(s) in various ways. Once a protocol(s) is accepted, a procedure may be completed using the accepted protocol(s). Once a procedure is completed, the exam package module 110 may output exam package information. As described below, exam package information may be various types of information, and the exam package module 110 may be configured to output exam package information in various ways. Once the procedure is completed, the billing module 112 may output billing information. As described below, billing information may be various types of information, and the billing module 112 may be configured to output billing information in various ways.

As mentioned above, the input module 102 may be configured to allow various types of procedure data to be input. For example, the input module 102 may be configured to allow a patient name, a patient identification code, a procedure name, a procedure identification code, an International Classification of Diseases (ICD-9) code, a referring physician name, a referring physician identification code, a radiologist name, and/or a radiologist identification code to be input. It may be desirable to configure the input module 102 to allow other types of procedure data to be input, as known to those skilled in the art.

The input module 102 may be configured to allow procedure data to be input in various ways. For example, the input module 102 may be configured to allow manual entry of procedure data. The input module 102 may also be configured to allow procedure data to be input from an electronic source, such as a library or a database, for example. The input module 102 may also be configured to allow procedure data to be input from a visual display, such as a display that lists procedure data, for example. It may be desirable to configure the input module 102 to allow procedure data to be input in other ways, as known to those skilled in the art.

As mentioned above, the procedure data input into the input module 102 is used by the protocol selection module 104 to select a protocol(s). Different procedure data may be used to select different parameters of a selected protocol(s). For example, in one embodiment of the system 100, a procedure may be broken into four stages: acquisition, image presentation, post processing, and data export. For each stage, different procedure data may be used to select parameters that make up a selected protocol(s).

The acquisition stage of a procedure may require patient information regarding the body part, organ and/or region of the body that is to be scanned, for example. The acquisition stage may also require patient information regarding disease, diagnosis and/or symptoms, for example. Thus, in one implementation of the system 100, procedure data, such as procedure name, procedure identification code, and/or disease/diagnosis/symptom code(s) may be used to select parameters of a protocol that relate to the acquisition stage of a procedure.

The image presentation stage of a procedure may require information regarding a radiologist's image viewing preferences. Images my be output in many formats, such as in a 4×4 matrix, one picture at a time, as a two dimensional image, and/or as a three dimensional image, for example. Thus, in one implementation of the system 100, procedure data such as radiologist name and/or radiologist identification code may be used to select parameters of a protocol that relate to the image presentation stage of a procedure.

The post processing stage of a procedure may require information regarding a radiologist's post processing preferences and/or information required during the acquisition stage of the procedure. Thus, in one implementation of the system 100, procedure data such as radiologist name, radiologist identification code, procedure name, procedure identification code, and/or disease/diagnosis/symptom code(s) may be used to select parameters of a protocol that relate to the post processing stage of a procedure.

The data export stage of a procedure may require information regarding post processing. For example, an image may require post processing by a workstation that is located elsewhere on a HIS and/or RIS. The data export stage of a procedure may also require information regarding a radiologist's and/or referring physician's preferred location for receiving images and/or reports. For example, a radiologist may prefer to review images on a certain PACS workstation. Thus, in one implementation of the system 100, procedure data such as radiologist name, radiologist identification code, referring physician name, referring physician identification code, procedure name, procedure identification code, and/or disease/diagnosis/symptom code(s) may be used to select parameters of a protocol that relate to the data export stage of a procedure.

It may be desirable to configure the protocol selection module 104 to select a protocol(s) in other ways, as known to those skilled in the art.

As mentioned above, once a protocol(s) is selected by the protocol selection module 104, the selected protocol(s) may be output by the output module 106. The output module 106 may be configured to output a selected protocol(s) and/or other information, such as procedure data, for example. It may be desirable to configure the output module 106 to output other information, as known to those skilled in the art.

The output module 106 may be configured to output a selected protocol(s) and/or other information in many ways. For example, the output module 106 may output a selected protocol(s) and/or other information as a visual display, an audio display, printed matter, a facsimile transmission, and/or electronic mail. It may be desirable to configure the output module 106 to output a selected protocol(s) and/or other information in other ways, as known to those skilled in the art.

As mentioned above, after a protocol(s) is output by the output module 106, the protocol may be edited using the protocol editing module 108. The protocol editing module 108 may be configured to allow the parameters of a protocol to be edited manually. For example, the parameters of a protocol may be manually edited by a technologist based on patient attributes, such as patient size, patient bone density, and/or symptoms/diagnosis. It may be desirable to configure the protocol editing module 108 to allow editing of a protocol(s) in other ways, as known by those skilled in the art.

Functionality provided by the protocol editing module 108 may be accessed in many ways. For example, in an embodiment where the output module 106 outputs a selected protocol(s) in a visual display, the functionality provided by the protocol editing module 108 may be accessed from a button displayed in the visual display created by the output module 106. Selecting the button may display a graphical user interface whereby the selected protocol may be edited, for example. It may be desirable to access the functionality provided by the protocol editing module 108 in other ways, as known to those skilled in the art.

As mentioned above, once a protocol(s) is accepted, a procedure may be completed using the accepted protocol(s). Once a procedure is completed, the exam package module 110 may output exam package information. Exam package information may be various types of information. For example, exam package information may be images and/or reports. It may be desirable to configure the exam package module 110 to output other types of exam package information, as known to those skilled in the art.

The exam package module 110 may be configured to output exam package information in various ways. For example the exam package module 110 may be configured to output exam package information as a visual display, an audio display, printed matter, a facsimile transmission, and/or electronic mail. In one embodiment of the system 100, the exam package module 110 may be configured to output exam package information to a PACS workstation. It may be desirable to configure the exam package module 110 to output exam package information in other ways, as known to those skilled in the art.

As mentioned above, once the procedure is completed, the billing module 112 may output billing information. Billing information may be various types of information. For example, billing information may include a patient name, a patient identification code, a referring physician's name, referring physician's identification code, a radiologist's name, a referring radiologist's code, a procedure name, a procedure identification code, a disease/symptom/diagnosis (ICD-9) code, scheduled procedure steps, performed procedure steps and/or Current Procedural Terminology (CPT) codes. It may be desirable to configure the billing module 112 to output other types of billing information, as known to those skilled in the art.

The billing module 112 may be configured to output billing information in various ways. For example the billing module 112 may be configured to output billing information as a visual display, an audio display, printed matter, a facsimile transmission, and/or electronic mail. It may be desirable to configure the billing module 112 to output billing information in other ways, as known to those skilled in the art.

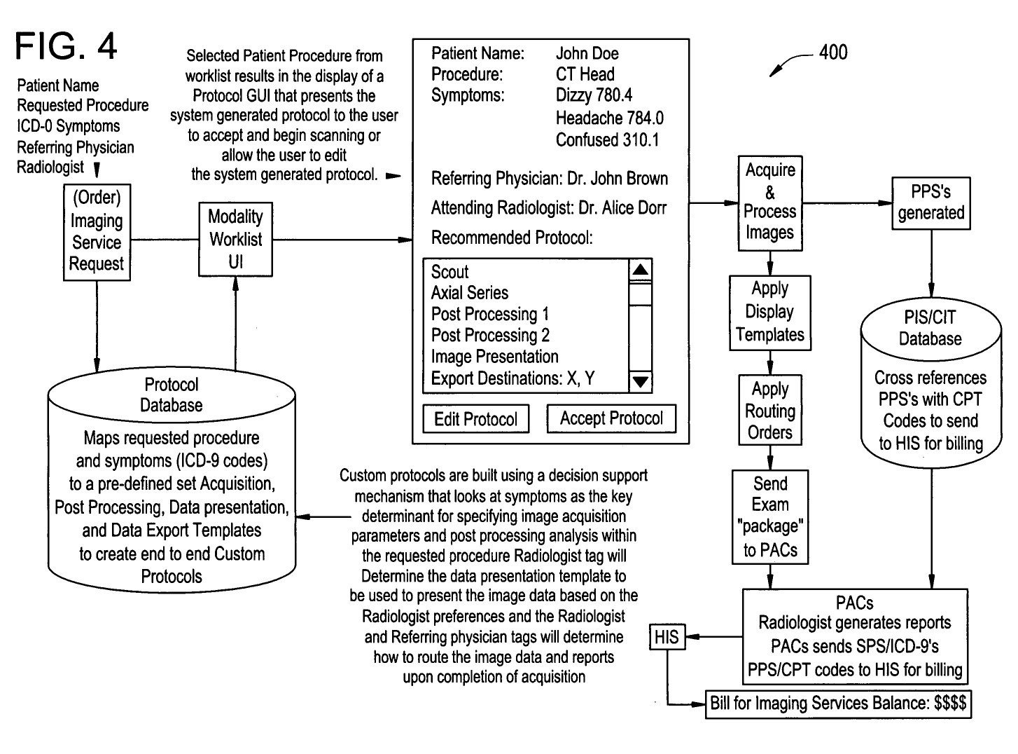

In operation, the protocol selection system 100 may be used in connection with a system like the one displayed in FIG. 4. First, procedure data may be input into the input module 102. For example, a patient name, a procedure name, an ICD-9 code(s), a referring physician name and/or a radiologist name may be entered as an imaging service request (order). Next, the input procedure data may be used by the protocol selection module 104 to select a protocol(s). For example, input procedure data may be sent to a protocol database that maps procedure data to protocol parameters. Image acquisition parameters may be determined based on a procedure name and an ICD-9 code(s). Image presentation parameters may be determined based on a referring physician name and/or a radiologist name. Post processing parameters may be determined based on a procedure name, an ICD-9 code(s), a referring physician name and/or a radiologist name. Data export parameters may be determined based on a procedure name, an ICD-9 code(s), a referring physician name and/or a radiologist name. Once a protocol is selected by the protocol selection module 104, the selected protocol may be output by the output module 106. For example, a visual display, such as a user interface of a Modality Worklist workstation, showing the input procedure data and the selected protocol may be output by the output module 106. A selected protocol may then be edited or accepted. For example, a visual display output by the output module 106 may have a button for editing the selected protocol and a button for accepting the selected protocol. If the edit button is selected, the protocol editing module 108 may be used to edit parameters of the selected protocol. For example, parameters of the selected protocol may be changed to reflect specific patient attributes by using a graphical user interface accessible from a visually displayed output from the output module 106. If the accept button is selected, the procedure may be completed using the selected protocol. For example, images may be acquired by the CT or MR scanner, then display templates may be applied to the images, and then routing orders may be applied to the images. Once the procedure is completed, the exam package module 110 may be used to output exam package information. For example, images and/or reports may be sent to a PACS workstation for a radiologist to review. Finally, the billing module 112 may be used to output billing information. For example, performed procedure steps may be sent to a database where the performed procedure steps may be mapped to Current Procedural Terminology (CPT) codes. Once the mapping is complete, the billing module 112 may send the performed procedure steps and related CPT codes to a PACS workstation. Then, the billing module 112 may send billing information, such as a procedure name, a procedure identification code, a disease/symptom/diagnosis (ICD-9) code, scheduled procedure steps, performed procedure steps and/or CPT codes, from the PACS workstation to an HIS and/or RIS billing application. The billing application may then assess the relationship between ICD-9 codes and the CPT codes to ensure that the diagnosis/symptoms/disease justify the performed procedure steps. Finally, the HIS and/or RIS may bill for the services rendered.

FIG. 2 illustrates a method 200 for protocol selection used in accordance with an embodiment of the present invention. At 202, procedure data may be input. For example, a patient name, a procedure name, a ICD-9 code(s), a referring physician name, and/or a radiologist name may be input manually and/or from an electronic source. At 204, a protocol may be selected. For example, procedure data may be used to select a protocol in a manner similar to that described with regard to FIG. 1. At 206, a protocol(s) may be output. For example, a selected protocol and the input procedure data may be output as a visual display, such as a user interface of a Modality Worklist workstation. At 208, a protocol(s) may be edited. For example, protocol parameters may be modified to reflect patient attributes. At 210, an exam package may be output. For example, images and/or reports generated during completion of the procedure may be output to a PACS workstation. At 212, billing information may be output. For example, billing information may be output to a database, then to a PACS workstation, and then to a HIS and/or RIS in a manner similar to that described with regard to FIG. 1.

Before an imaging study may be conducted, a protocol(s) must be selected and/or edited. However, it may be difficult and/or time consuming to select a proper protocol(s) because current systems do not streamline and/or automate the protocol selection process. Applying the method 200, as described above and/or in light of the description of FIG. 1, may aid radiologists in quickly selecting a proper protocol(s) by providing a protocol(s) based on procedure data, such as a patient name, a procedure name, a ICD-9 code(s), a referring physician name, and/or a radiologist name.

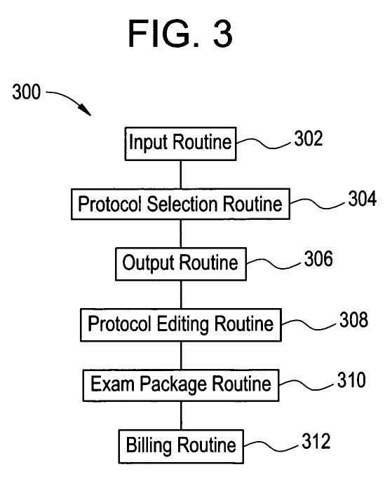

FIG. 3 illustrates a set of computer instructions 300 for protocol selection used in accordance with an embodiment of the present invention. The set of computer instructions 300 for protocol selection includes an input routine 302, a protocol selection routine 304, an output routine 306, a protocol editing routine 308, an exam package routine 310, and a billing routine 312. The set of computer instructions 300 may be implemented on systems and workstations connected to a HIS and/or a RIS, such as a CT imaging systems, a MR imaging systems, a Modality Worklist workstation, a PACS workstation and/or a billing system, for example. The set of computer instructions 300 may be implemented on other types of systems and workstations, as known to those skilled in the art.

In the set of computer instructions 300 for protocol selection, the input routine 302 allows procedure data to be input. The protocol selection routine 304 allows a protocol(s) to be selected based on input procedure data. The output routine 306 allows a selected protocol(s) to be output. The protocol editing routine 308 allows a selected protocol to be edited. The exam package routine 310 allows exam package information to be output. The billing routine 312 allows billing information to be output.

In an embodiment, the input routine 302, the protocol selection routine 304, the output routine 306, the protocol editing routine 308, the exam package routine 310, and the billing routine 312, may perform functions similar to the input module 102, the protocol selection module 104, the output module 106, the protocol editing module 108, the exam package module 110, and the billing module 112, respectively, as described above in relation to FIG. 1.

Thus, certain embodiments of the present application provide a system, method and computer instructions for protocol selection. Certain embodiments select a protocol(s) based on procedure data entered manually and/or from an electronic source, for example. Certain embodiments output a selected protocol and input procedure data as a visual display, for example. Certain embodiments allow editing of a selected protocol(s), for example. Certain embodiments output exam package information such as an image and/or a report, for example. Certain embodiments output billing information, for example.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A protocol selection system comprising:
an input module for inputting procedure data;
a protocol selection module for selecting a protocol based on said procedure data; and
an output module for outputting a selected protocol.

2. The system of claim 1, wherein said procedure data is one of: a procedure; and an International Classification of Diseases code.

3. The system of claim 1, wherein said procedure data is one of: a patient name; a referring physician name; and a radiologist name.

4. The system of claim 1, further comprising a protocol editing module for editing a protocol.

5. The system of claim 1, further comprising an exam package module for outputting exam package information based on said selected protocol.

6. The system of claim 5, wherein said exam package information is one of: an image; and a report.

7. The system of claim 1, further comprising a billing module for outputting billing information based on said selected protocol.

8. A protocol selection method comprising:
inputting procedure data;
selecting a protocol based on said procedure data; and
outputting a selected protocol.

9. The method of claim 8, wherein said procedure data is one of: a procedure; and an International Classification of Diseases code.

10. The method of claim 8, wherein said procedure data is one of: a patient name; a referring physician name; and a radiologist name.

11. The method of claim 8, further comprising editing a protocol.

12. The method of claim 8, further comprising outputting exam package information based on said selected protocol.

13. The method of claim 12, wherein said exam package information is one of: an image; and a report.

14. The method of claim 8, further comprising outputting billing information based on said selected protocol.

15. A computer-readable storage medium including a set of instructions for a computer, the set of instructions comprising:
an input routine for inputting procedure data;
a protocol selection routine for selecting a protocol based on said procedure data; and
an output routine for outputting a selected protocol.

16. The set of instructions of claim 15, wherein said procedure data is one of: a procedure; and an International Classification of Diseases code.

17. The set of instructions of claim 15, wherein said procedure data is one of: a patient name; a referring physician name; and a radiologist name.

18. The set of instructions of claim 15, further comprising a protocol editing routine for editing a protocol.

19. The set of instructions of claim 15, further comprising an exam package routine for outputting exam package information based on said selected protocol.

20. The set of instructions of claim 19, wherein said exam package information is one of: an image; and a report.

21. The set of instructions of claim 15, further comprising a billing routine for outputting billing information based on said selected protocol.
